(19) United States
(12) Patent Application Publication
(10) Pub. No.: US 2003/0117341 A1
(43) Pub. Date: Jun. 26, 2003

(54) Bookview system

(76) Inventor: Scott Browning, Hollywood, CA (US)

Correspondence Address: COWAN, LIEBOWITZ & LATMAN, P.C., 1133 AVENUE OF THE AMERICAS, NEW YORK, NY, 10036, US

(21) Appl. No.: 10/025,329

(22) Filed: Dec. 19, 2001

(51) Int. Cl. G09G 5/00

(52) U.S. Cl. 345/1.1

(57) ABSTRACT

The BookView System is a device that allows consumers to view video book trailers in locations where books are sold. The device contains the elements of a display monitor with speakers and/or headphones, and a selection method that the consumer can use to choose which trailers to watch. The BookView System is a device that can be configured according to the needs and retail space of the bookseller. The BookView System also contains a central processing unit that controls the delivery of the video and audio based on the book the consumer has selected to preview.

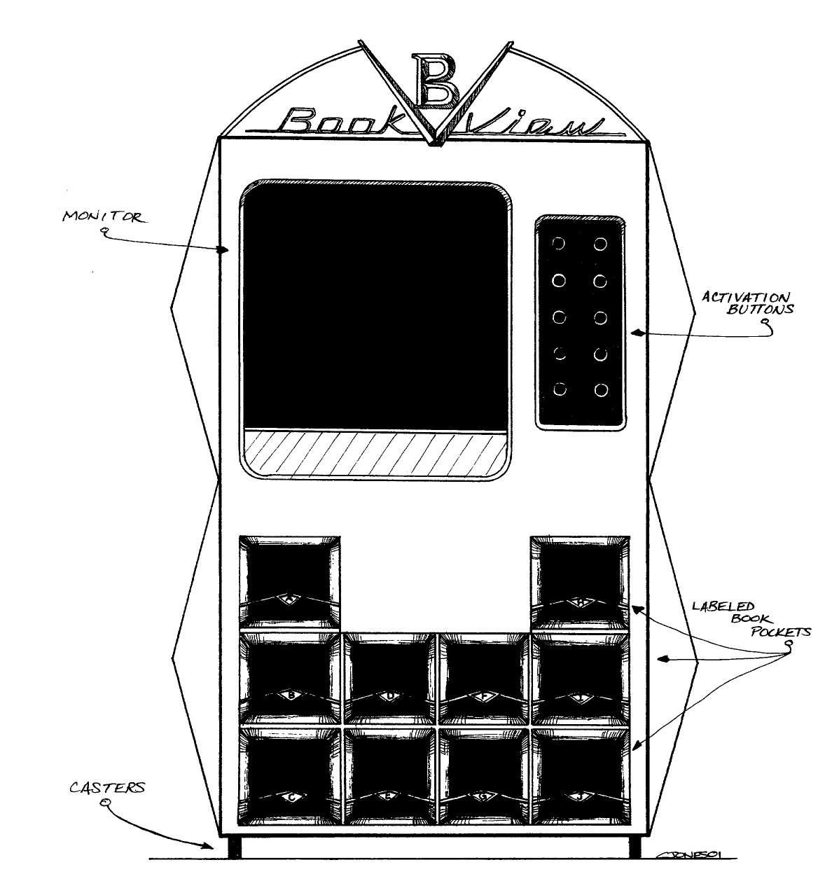

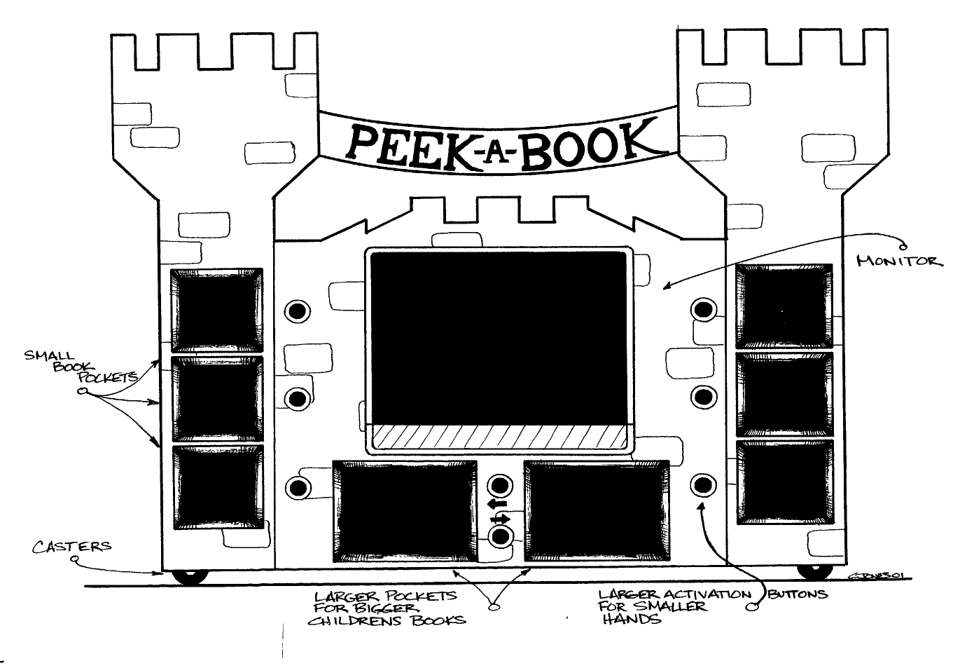

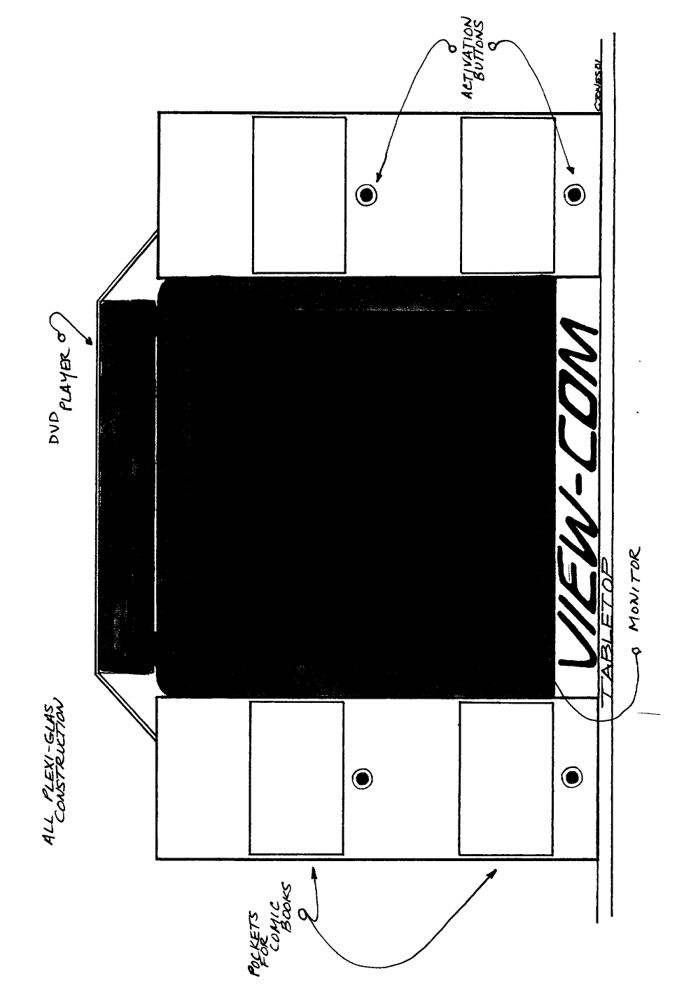

I am also claiming patent protection for video book trailers that are displayed in locations where books are sold and on the Internet in and through venues where books are sold. These trailers, whether using live action or animated images, provide a brief summary of a book's content and usefulness for non-fiction titles, or for fiction titles, a synopsis of the plot and character highlights.

### CROSS-REFERENCE TO RELATED APPLICATIONS

Not Applicable

### STATEMENT REGARDING FEDERALLY SPONSORED RESEARCH

Not Applicable

### REFERENCE TO SEQUENCE LISTING

Not Applicable

### BACKGROUND OF THE INVENTION

The BookView System is a device that allows consumers to preview book trailers for published books. As the author of a published book, I recently created a “book trailer” that allows consumers to preview the book by watching a short animated video that provides highlights from the book. Similar to movie trailers one sees in a movie theater that give short previews or “coming attractions” of upcoming movies, the book trailer serves as a preview of the substance of my book. I created this trailer using my unique knowledge and experience of books and audio/video creation techniques. To my knowledge, no one has ever previously created a video book trailer for books that is displayed in locations where books are sold, and the patent I am claiming is on the display system that enables consumers to view these book trailers, as well as the trailers themselves when presented on the display system.

### BRIEF SUMMARY OF THE INVENTION

The BookView System is a display device that allows consumers to view video book trailers in locations where books are sold so they can make a more informed purchasing decision.

### BRIEF DESCRIPTION OF THE SEVERAL VIEWS OF THE DRAWING

With this filing, I have included three drawings to show possible examples of the BookView System as it might be used. These drawings depict the front of a stand-alone system and all contain the features of a video monitor, speakers, pockets to hold the books, and selection buttons. The difference between the drawings concerns the different types and sizes of the System that might be used depending on the desires of the retailer using it.

“Exhibit A” shows a system that could be used to display adult fiction or non-fiction book trailers.

“Exhibit B” shows a system that could be used to display children's book trailers.

“Exhibit C” shows a system that could be used to display comic book trailers.

### DETAILED DESCRIPTION OF THE INVENTION

The BookView System is a device that includes three main elements: 1) display monitor with speakers and/or headphones to view the video and listen to audio of the book trailer; 2) a selection method that allows users to select the trailer of their choice; and 3) a central processing unit that allows for the electronic storage, selection and delivery/playback of the book trailers.

The BookView System can be modified and configured depending on the needs of the bookseller. For example, a larger retail establishment may choose a unit that could offer video trailers for a greater number of books. Depending on retail space, the device itself, including a large 20″ monitor, might be as large as 6 feet tall and 4 feet wide and provide options to view trailers for dozens of books. Conversely, in a smaller retail space, the BookView System might stand on a table and utilize a smaller 12″ monitor with several pockets to hold a small number of books, and could utilize a small DVD machine to display the trailers.

1) What I claim as my invention is the BookView System, a display device that allows consumers to view video book trailers in locations where books are sold. There are currently no other systems on the market being used by book retailers that allow consumers to preview books in video form. Although inventors have filed patents on devices to allow consumers to preview movie trailers, sound samples and video games, these devices do not display book trailers. Since my BookView System is a first-to-market device for displaying these trailers, I am seeking patent protection.

2) I am also seeking patent protection on the Video Book Trailers that are shown on the BookView System. Through my own unique methods, I am the first to develop video book trailers that are displayed in locations where books are sold. These video book trailers are designed to provide the viewer with information about the book to enable them to make a more informed purchasing decision. For example, these trailers, using live action or animated images, could include a brief summary of a book's content and usefulness for non-fiction titles, or for fiction titles, a synopsis of the plot and character highlights. To my knowledge, no one has ever previously created a video book trailer that is displayed in locations where books are sold. Since I have invented the concept of creating and displaying a first-to-market video book trailer in locations where books are sold, I am seeking patent protection for this concept.

3) I am also seeking patent protection on Video Book Trailers that are displayed on the Internet in or through venues where books are sold. Through my own unique methods, I am the first to develop video book trailers that are displayed on the Internet in or through venues where books are sold. These video book trailers are designed to provide the viewer with information about the book to enable them to make a more informed purchasing decision. For example, these trailers, using live action or animated images, could include a brief summary of a book's content and usefulness for non-fiction titles, or for fiction titles, a synopsis of the plot and character highlights. Since I have invented the concept of creating and displaying a first-to-market video book trailer on the Internet in or through venues where books are sold, I am seeking patent protection for this concept.
